(19) United States
(12) Patent Application Publication
(10) Pub. No.: US 2024/0072602 A1
(43) Pub. Date: Feb. 29, 2024

(54) MOTOR AND BLOWER USING THE SAME AND CARTRIDGE FOR MOTOR

(71) Applicant: MINEBEA MITSUMI Inc., Kitasaku-gun (JP)

(72) Inventor: Shinichi UCHIKAWA, Kitasaku-gun (JP)

(21) Appl. No.: 18/503,547

(22) Filed: Nov. 7, 2023

Related U.S. Application Data
(63) Continuation of application No. PCT/JP2022/009067, filed on Mar. 3, 2022.

(30) Foreign Application Priority Data
May 13, 2021 (JP) 2021-081895

(51) Int. Cl. H02K 5/173; F04D 25/06; F04D 29/056; F04D 29/32; F16C 19/18; H02K 7/08; H02K 21/22

(52) U.S. Cl. CPC H02K 5/1735; F04D 25/06; F04D 29/0563; F04D 29/325; F16C 19/18; H02K 7/085; H02K 21/22; F16C 2360/46

(57) ABSTRACT

To provide a motor capable of suppressing movement of a shaft, bearings, or the like with respect to a case, a blower using the motor, and a cartridge for the motor. The motor includes a shaft, a rotor fixed to the shaft, a stator opposed to the rotor, a pair of bearings fixed to the shaft, a sleeve surrounding the pair of bearings, and a case including a support part configured to support the sleeve. The sleeve includes, in an axis X direction of the shaft, an engagement part configured to engage with the case.

### CROSS REFERENCE TO RELATED APPLICATIONS

This application is a continuation of International Application No. PCT/JP2022/009067, filed on Mar. 3, 2022, which claims priority to Japanese Patent Application Number 2021-081895, filed on May 13, 2021, which is incorporated herein by reference.

### TECHNICAL FIELD

The disclosure relates to a motor, a blower using the same, and a cartridge for the motor.

### BACKGROUND

Conventionally, in a motor of a blower with an impeller rotatably supported by bearings (in particular, ball bearings), a pair of bearings disposed to be spaced apart from each other in an axial direction are generally fitted or press-fitted into a tubular part provided in a case, or fitted or press-fitted into an inner circumference of a sleeve fixed to the case (see, for example, JP 2001-16820 A and JP 2005-76473 A).

For example, in a blower with an impeller attached to a shaft, due to the rotation of the impeller, a force acts to move a bearing cartridge including the shaft, members rotating integrally with the impeller, and the like toward the upper side in the axial direction (a force like a lift force of a helicopter acts). When such a force to come off in the axial direction acts, sufficient fixing strength is required against the force.

Such a state of a force acting to move the shaft or the bearing in the axial direction is not limited to a blower with an impeller attached to the shaft, but is often observed in various motor usage situations. That is, a motor with a shaft, bearings, or the like being unlikely to move in the axial direction is also desired for applications besides a blower.

### SUMMARY

One of the objects of the disclosure is to provide a motor capable of suppressing movement of a shaft, bearings, or the like with respect to a case, a blower using the motor, and a cartridge for the motor.

The above problem is solved by the disclosure described below. That is, the motor of the disclosure includes:
a shaft;
a rotor fixed to the shaft;
a stator opposed to the rotor;
a pair of bearings fixed to the shaft;
a sleeve surrounding the pair of bearings; and
a case including a support part configured to support the sleeve, wherein
the sleeve includes an engagement part configured to engage with the support part of the case in an axial direction of the shaft.

### BRIEF DESCRIPTION OF DRAWINGS

FIG. 1 is a cross-sectional view of a blower with a motor applied, according to the present embodiment, and corresponds to a cross-sectional view taken along A-A cross section in FIG. 2.

FIG. 2 is a perspective view of the blower with the motor applied, according to the present embodiment.

FIG. 3 is an enlarged cross-sectional view of a bearing cartridge in the present embodiment.

FIG. 4 is an exploded cross-sectional view of the bearing cartridge in the present embodiment.

FIG. 5 is an exploded perspective view illustrating a state of extracting the bearing cartridge only from the blower with the motor applied, according to the present embodiment.

FIG. 6 is an exploded cross-sectional view of the blower with the motor applied, according to the present embodiment.

FIG. 7 is an exploded cross-sectional view of the blower with the motor applied, according to the present embodiment, illustrating a state of the bearing cartridge being inserted into a case from the state illustrated in FIG. 6.

FIG. 8 is an exploded cross-sectional view of the blower with the motor applied, according to the present embodiment, illustrating a state of a stator assembly being inserted into and fixed to the bearing cartridge from the state illustrated in FIG. 7.

FIG. 9 is an enlarged cross-sectional view of a projecting part of a sleeve and the periphery of the projecting part in the motor according to the present embodiment.

FIG. 10 is an enlarged perspective view of the sleeve according to the present embodiment.

FIG. 11 is an enlarged perspective view of a sleeve according to a modified example.

FIG. 12 is a perspective view of a blower including a motor with the sleeve of the modified example applied and illustrated in FIG. 11.

FIG. 13 is an exploded perspective view illustrating a state of extracting a bearing cartridge alone from the blower provided with the motor with the sleeve of the modified example applied and illustrated in FIG. 11.

FIG. 14 is an exploded cross-sectional view illustrating an exploded state of the bearing cartridge of the modified example capable of applying a preload to a pair of bearings without using an urging member.

FIG. 15 is a cross-sectional view of the bearing cartridge in the modified example illustrated in the exploded state in FIG. 14.

FIG. 16 is an explanatory view schematically illustrating the action of a preload on the pair of bearings in the bearing cartridge of the modified example illustrated in FIG. 15.

FIG. 17 is an exploded cross-sectional view illustrating an exploded state of a bearing cartridge of another modified example capable of applying a preload to a pair of bearings without using an urging member.

FIG. 18 is a cross-sectional view of the bearing cartridge of the modified example illustrated in the exploded state in FIG. 17.

FIG. 19 is an explanatory view schematically illustrating the action of a preload on the pair of bearings in the bearing cartridge of the other modified example illustrated in FIG. 18.

### DESCRIPTION OF EMBODIMENTS

A motor 100 according to an embodiment being an exemplary aspect of the disclosure will be described below with reference to the drawings. That is, the examples indicate the motor 100 according to the present embodiment being applied to a blower 101 discharging air suctioned from above to below by rotating an impeller 22.

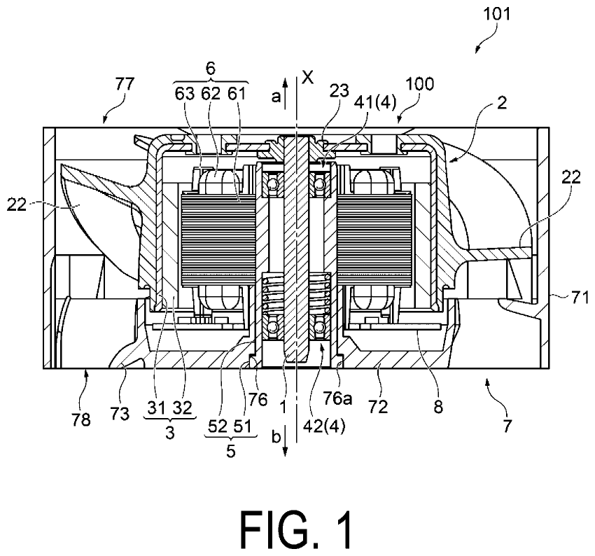

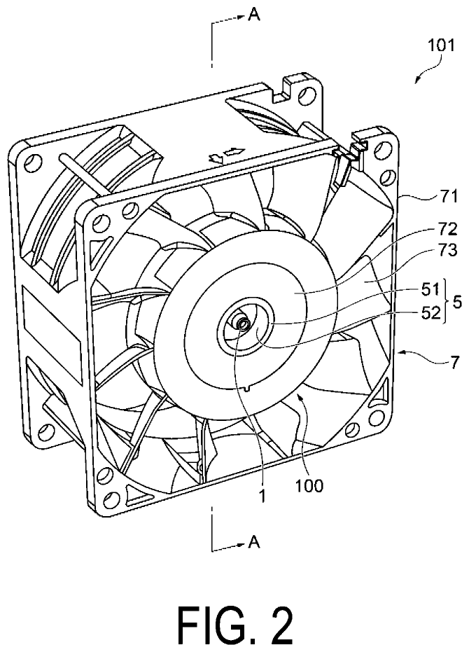

FIG. 1 is a cross-sectional view of the blower 101 with the motor 100 applied, according to the present embodiment, and FIG. 2 is a perspective view of the blower 101. FIG. 1 corresponds to a cross-sectional view taken along an A-A cross section in FIG. 2.

Note that in the description of the present embodiment, for convenience, an extending direction of an axial line X of an axis of a shaft 1 when the motor 100 rotates is referred to as a rotation axis X direction, an axial line X direction, or simply an axial direction.

In the description of the present embodiment, for convenience, in the rotation axis X direction, an arrow a direction is referred to as an upper side, and an arrow b direction is referred to as a lower side. The upper side (arrow a direction) and the lower side (arrow b direction) mean an up-down relationship of the motor 100 in the drawings, and do not necessarily correspond to an up-down relationship in the gravitational direction.

Also, in the present embodiment, a “circumferential direction” means the circumferential direction of a circle about the rotation axial line X of the shaft 1.

As illustrated in FIG. 1, the motor 100 of the blower 101 includes the shaft 1, a hub 2 made of resin fixed to one end of the shaft 1, a rotor 3 attached to an inner circumference of the hub 2, bearings 4 fixed to the shaft 1, a sleeve 5 having a tubular shape surrounding and accommodating outer circumferential parts (outer rings) of the bearings 4, a stator 6 fixed to an outer circumferential part of the sleeve 5, and a case 7 covering the rotor 3 and internally accommodating components of the motor 100. The rotor 3 is fixed to the shaft 1 via the hub 2.

The shaft 1 is located at a center viewed from above the motor 100 and extends in the vertical direction. The shaft 1 is formed of a metal, such as stainless steel. The hub 2 is fixed to one end (upper end in FIG. 1) of the shaft 1. The shaft 1 and the hub 2 are fixed by a coupling member 23.

The rotor 3 is fixed to the inner circumferential surface of the hub 2, and the impeller (rotor blade) 22 is fixed to an outer circumferential surface of the hub 2. The rotor 3 includes a yoke 31 having a cup shape fitted in the hub 2 having a cup shape, and a magnet 32 attached to an inner circumferential surface of the yoke 31 in a state of surrounding the stator 6. The hub 2 and the rotor 3 have opening portions opening downward (in the arrow b direction, that is, toward an outlet port side).

The yoke 31 is formed of a magnetic body, but may be formed of a non-magnetic body, such as aluminum, when there is no problem in characteristics. The magnet 32 is attached to the inner circumferential surface of the yoke 31 so as to oppose the stator 6. The magnet 32 has an annular shape, and includes a region magnetized to the north pole and a region magnetized to the south pole, alternately provided along the circumferential direction at a constant period.

The shaft 1 is fitted and fixed into a plurality of the bearings 4. The plurality of bearings 4 include a first bearing 41 and a second bearing 42, and the first bearing 41 and the second bearing 42 are attached to the shaft 1 at a given interval. The first bearing 41 is located close to the upper side (in the arrow a direction, that is, on the suction port side) of the shaft 1 fixed to the coupling member 23 of the hub 2. The second bearing 42 is located close to the lower side (in the arrow b direction, that is, on the outlet port side).

The pair of bearings 4 (41, 42) are accommodated in the sleeve 5. The sleeve 5 is a member having a tubular shape (in particular, cylindrical shape), and is formed of a resin, such as plastic, or a metal, such as a magnetic body or a non-magnetic body. In order not to change the preload states of the bearings 4, it is preferable for the linear expansion coefficient of the sleeve 5 to be substantially equal to the linear expansion coefficient of the shaft 1.

The sleeve 5 includes a projecting part 51 provided at an end part on the lower side (in the arrow b direction, that is, on the outlet port side) and a tubular part 52 having a cylindrical shape.

In the present embodiment, the shaft 1, the sleeve 5, the first bearing 41, the second bearing 42, and a spring 43 as an elastic body to be described below constitute a cartridge 9 (hereinafter, referred to as a “bearing cartridge”) as one bearing device.

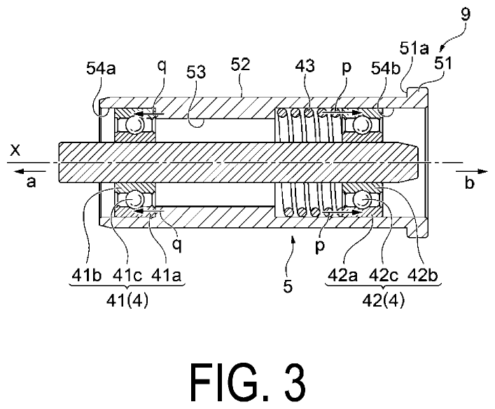

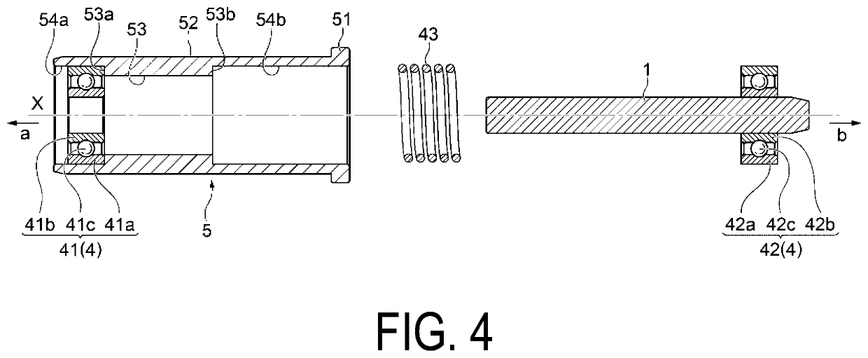

FIG. 3 illustrates an enlarged cross-sectional view of the bearing cartridge 9 in the present embodiment. FIG. 4 illustrates an exploded cross-sectional view of the bearing cartridge 9 in the present embodiment. Note that the arrows a and b indicating the vertical directions in the rotation axis X direction are illustrated as horizontal directions in the drawings of FIGS. 3 and 4.

As illustrated in FIGS. 3 and 4, the pair of bearings 4 are so-called ball bearings including outer rings 41a, 42a, inner rings 41b, 42b, and balls (bearing balls) 41c, 42c interposed between the outer rings 41a, 42a and the inner rings 41b, 42b. Due to the balls 41c rolling between the outer ring 41a and the inner ring 41b, a rotational resistance of the inner ring 41b with respect to the outer ring 41a is significantly reduced. In consideration of the function, the first bearing 41 is formed, for example, of a hard metal, such as stainless steel, or a ceramic. The shaft 1 is fixed at the inner rings 41b and 42b, and is rotatable with respect to the outer rings 41a and 42a.

The projecting part 51 of the sleeve 5 is a flange-shaped part projecting radially outward from an end part on the lower side b of the tubular part 52. That is, the projecting part 51 projects in the radial direction from an inner circumferential surface toward the outer circumferential surface of the sleeve 5.

The inner circumferential surface of the sleeve 5 includes: in the axial line X direction, a center part and a region closer to the upper side a with respect to the center part protruding toward the axial line X as a protruding part (small-diameter inner circumferential part, hereinafter, sometimes referred to as a “spacer part”) 53, a region on the upper side a with respect to the spacer part 53 being recessed in a direction away from the axial line X as a first recessed part (large-diameter inner circumferential part) 54a, and a region on the lower side b with respect to the spacer part 53 being recessed similarly to the first recessed part 54a as a second recessed part (large-diameter inner circumferential part) 54b. Hereinafter, in terms of the size of the inner diameters, the spacer part 53 may be referred to as a small inner-diameter part 53, the first recessed part 54a may be referred to as a first large-inner-diameter part 54a, and the second recessed part 54b may be referred to as a second large-inner-diameter part 54b.

Note that, the sleeve 5 may be integrally formed by a known method so as to have a shape including the small inner-diameter part 53, the first large-inner-diameter part 54a, and the second large-inner-diameter part 54b. For example, the sleeve 5 may be formed of two or more members by inserting a circular tube with a small diameter (hereinafter referred to as a “small-diameter circular tube”) having the same inner diameter as the inner diameter of the small inner-diameter part 53 and the same outer diameter as the inner diameter of the first and second large-inner-diameter parts 54a, 54b into a circular tube with a large diameter (hereinafter referred to as a “large-diameter circular tube”) having the inner and outer diameters of the first and second large-inner-diameter parts 54a, 54b, such that the small-diameter circular tube is located at a center part of the large-diameter circular tube and closer to the upper side a with respect to the center part in the axial line X direction. Here, the small-diameter circular tube and the large-diameter circular tube may be formed by members of different materials or may be formed by members of the same material.

The outer diameters of the bearings 4 are larger than the inner diameter of the small inner-diameter part 53 and smaller than the inner diameters of the first large-inner-diameter part 54a and the second large-inner-diameter part 54b. That is, the bearings 4 have the outer diameters allowing the bearings 4 to be fitted into the first large-inner-diameter part 54a and the second large-inner-diameter part 54b, but not allowing the bearings to be fitted into the small inner-diameter part 53.

When the bearing cartridge 9 is assembled, first, as illustrated in FIG. 4, the outer ring 41a of the first bearing 41 located the upper side a of the shaft 1 is fitted into the first large-inner-diameter part 54a of the sleeve 5, and is positioned by a stepped part 53a at the boundary between the small inner-diameter part 53 and the first large-inner-diameter part 54a. Then, the first bearing 41 is fixed to and supported by the sleeve 5 appropriately by an adhesive, light press-fitting, press-fitting, or the like.

The inner diameters of the bearings 4 are substantially the same as or slightly smaller than the outer diameter of the shaft 1. The shaft 1 is relatively easily fitted, light press-fitted, or press-fitted into the bearing 4. As illustrated in FIG. 4, the shaft 1 fits into the inner ring 42b of the second bearing 42, and is fixed and supported at a position on the lower side b of the shaft 1 appropriately by an adhesive, light press-fitting, press-fitting, or the like.

The outer diameter of the spring 43 is larger than the inner diameter of the small inner-diameter part 53 and smaller than the inner diameter of the second large-inner-diameter part 54b. That is, the spring 43 has the outer diameter allowing the spring 43 to be inserted into the second large-inner-diameter part 54b, but not allowing the spring 43 to be inserted into the small inner-diameter part 53. As illustrated in FIG. 4, the spring 43 is inserted into the second large-inner-diameter part 54b of the sleeve 5 from the lower side b of the shaft 1, and also from the lower side b, the shaft 1 fixed to and supported by the second bearing 42 enters the second large-inner-diameter part 54b of the sleeve 5 with the axial line X direction as the center axis.

A tip end on the upper side a of the shaft 1 advances in the upper side a direction, and fits into the inner ring 41b of the first bearing 41. On the other hand, on the lower side b of the shaft 1, the attached second bearing 42 is fitted into the second large-inner-diameter part 54b. The spring 43 fitted into the second large-inner-diameter part 54b is pushed toward the upper side a until coming into contact with a stepped part 53b at the boundary between the small inner-diameter part 53 and the second large-inner-diameter part 54b, and is positioned by the second bearing 42 attached to the shaft 1.

Then, the second bearing 42 advances toward the upper side a in the second large-inner-diameter part 54b, and is fixed to the sleeve 5 at a predetermined position illustrated in FIG. 3 appropriately by an adhesive, light press-fitting, press-fitting, or the like. At the same time, the inner ring 41b of the first bearing 41 fitted with the shaft 1 is fixed and supported at a position on the upper side a of the shaft 1 appropriately by an adhesive, light press-fitting, press-fitting, or the like.

The outer rings 41a, 42a of the pair of bearings 41, 42 are fitted into and fixed to the first and second large-inner-diameter parts 54a, 54b of the sleeve 5, respectively, and are supported by the sleeve 5. On the other hand, the shaft 1 is fitted into and fixed to the inner rings 41b, 42b of the pair of bearings 41, 42, and is supported by the pair of bearings 41, 42. Therefore, the shaft 1 is supported so as to be rotatable with respect to the sleeve 5.

As described above, the bearing cartridge 9 is assembled. Here, the spring 43 is in a state of being sandwiched and compressed between the stepped part 53b and the second bearing 42, and acts to urge the stepped part 53b and the second bearing 42 by the elasticity of the spring 43 itself. The spring 43 is in contact with the outer ring 42a of the second bearing 42, and applies a preload urging the outer ring 42a in the arrow p direction in FIG. 3.

Further, when the first bearing 41 is fitted into the sleeve 5, the outer ring 41a is positioned with respect to the stepped part 53a, and is fixed by an adhesive or press-fitting in a preload application state. That is, a preload urging the outer ring 41a in the arrow q direction in FIG. 3 is applied to the first bearing 41.

As described above, in the present embodiment, since the preloads are applied to the pair of bearings 4 by the urging force of the spring 43 and the so-called fixed position preload via the stepped part 53a, rattling of the bearings 4 can be suppressed. Therefore, the shaft 1 smoothly rotates, and high-speed rotation and high durability of the motor 100 (further, the blower 101) can be realized.

In the present embodiment, the shaft 1, the sleeve 5, the spring 43, the first bearing 41, and the second bearing 42 constitute one bearing cartridge 9. By forming the bearing cartridge 9 as one component in a state of the shaft 1, the first bearing 41, and the second bearing 42 being assembled to the sleeve 5 in advance, the assembly operation is facilitated at the time of manufacturing. In addition, for example, when the bearings 4 are broken, since it is sufficient to replace the bearing cartridge 9 as a whole, the replacement operation is easy and a repair can be performed in a simple operation. Moreover, replacing the bearing cartridge 9 alone instead of replacing the entire motor 100 also leads to a low cost.

Also, it is relatively easy to adjust the rotational balance in a state of the bearing cartridge 9 being in a stage with a small number of parts. Thus, by adjusting the rotational balance in the state of the bearing cartridge 9, when manufacturing or repairing the motor or after manufacturing or repairing the motor, the adjustment operation of the rotational balance can be omitted or can be performed by a simple operation, and thus the manufacturing or repairing operation can be simplified. Thus, also in the above respect, the present embodiment also possibly leads to the low cost.

The bearing cartridge can be constituted by three parts of the sleeve 5, the first bearing 41, and the second bearing 42, or four parts including the spring 43, without inserting the shaft 1 into the plurality of bearings 4. With the bearing cartridge being in a state of the shaft 1 being incorporated into the three parts or four parts, the adjustment of the rotational balance in the state of the bearing cartridge can be performed more accurately, and the manufacturing or repairing operation can also be made easier. Note that, the configuration not including the spring 43 will be described in detail below.

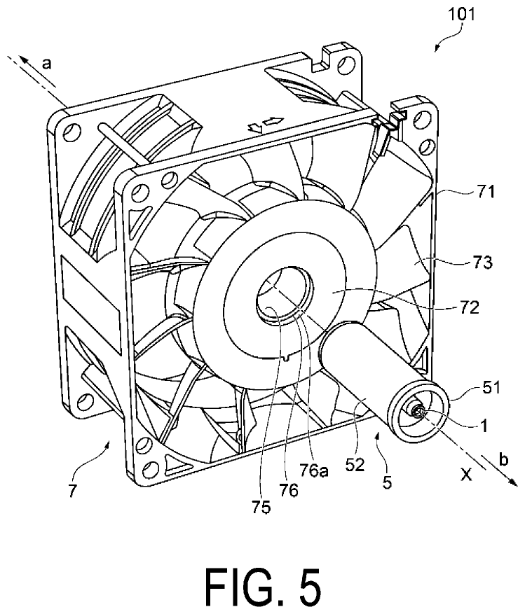

FIG. 5 is an exploded perspective view illustrating a state of extracting the bearing cartridge 9 alone from the blower 101 with the motor 100 applied. The bearing cartridge 9 is fitted into and fixed to a tubular part of the case 7 to be described below from an end part on the side opposite (upper side a) to the projecting part 51, and thus fixed to the case 7. The shaft 1 supported by the bearings 4 is supported so as to be rotatable with respect to the case 7.

As illustrated in FIG. 1, the stator 6 surrounding the sleeve 5 includes a stator core 61, a coil 62, and an insulator 63. The stator 6 has an inner circumferential side fixed to the tubular part 52 of the sleeve 5.

The stator core 61 is a stacked body of annular magnetic bodies (silicon steel plates or the like) disposed coaxially with the shaft 1.

The coil 62 is wound around the stator core 61. The stator core 61 and the coil 62 are insulated by the insulator 63 formed of an insulator. Note that, instead of the insulator 63, the surface of the stator core 61 may be coated with an insulating film to be insulated from the coil 62. A circuit board 8 in a doughnut shape having an inner circumferential part and an outer circumferential part is fixed to an end part on the lower side b of the insulator 63.

The case 7 includes a side wall part 71 having a tubular shape surrounding the motor 100 including the impeller 22, a bottom wall part 72 located at a portion of an opening on the lower side b of the side wall part 71, and a stationary blade 73 coupling the bottom wall part 72 and the side wall part 71 at the opening on the lower side b. The stationary blade 73 is formed by a plurality of blades radially extending and having a rectifying surface from the bottom wall part 72 toward the side wall part 71.

The case 7 is formed of, for example, a resin material or a metal material. The case 7 covers components of the motor 100, such as the rotor 3, and most (all fixed ones) of the components of the motor 100 and the blower 101, such as the rotor 3 and the stator 6, as well as the hub 2, are accommodated in an internal space of the case 7.

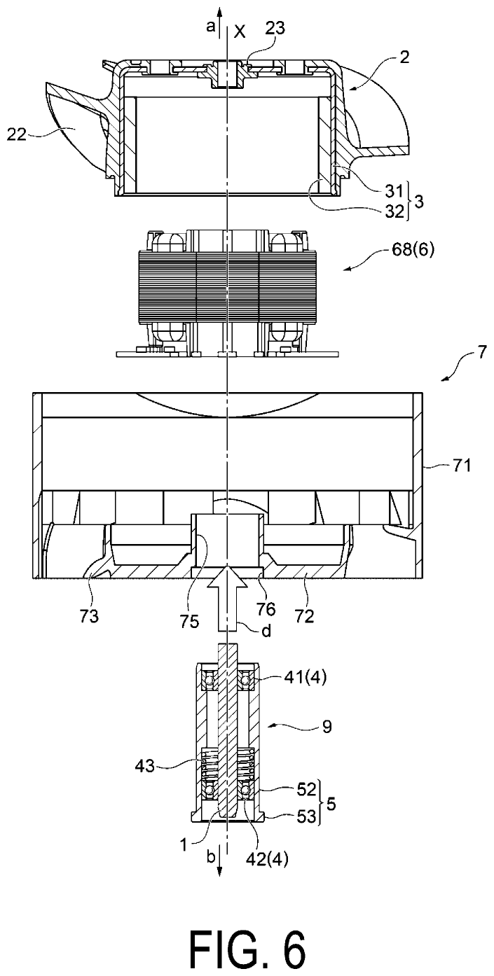

FIG. 6 is an exploded cross-sectional view of the blower 101 with the motor 100 applied. As illustrated in FIG. 6, the case 7 includes a tubular part (hereinafter referred to as a “case tubular part”) 75 having a cylindrical shape. The case tubular part 75 extends from the bottom wall part 72 toward the upper side a, and is formed integrally with the bottom wall part 72.

The bearing cartridge 9 is inserted into the case tubular part 75 from an end part (upper side a) of the sleeve 5 opposite to the projecting part 51 (see arrow din FIG. 6), and is fixed by light press-fitting and/or an adhesive. With the sleeve 5 being fixed to the case tubular part 75, as illustrated in FIG. 1, the bearing cartridge 9 is fixed to the case 7.

At an end part on the lower side b of the case tubular part 75, a stepped part (hereinafter referred to as an “engagement receiving part”) 76 as a support part supporting the sleeve 5 is formed. In the axial direction of the shaft 1 (axial line X direction), the projecting part 51 as the engagement part is opposed to the engagement receiving part 76 as the support part of the case 7. With the stepped part 76 as a boundary, the inner diameter on the upper side a of the case tubular part 75 is larger than the inner diameter on the lower side b.

An inner circumferential surface and a stepped surface opposing the lower side b of the engagement receiving part 76 are opposed to the outer circumferential surface and a stepped surface opposing the upper side a of the projecting part 51 of the sleeve 5. The inner circumferential surface and the stepped surface facing the lower side b of the engagement receiving part 76, and the outer circumferential surface and the stepped surface facing the upper side a of the projecting part 51 of the sleeve 5 have substantially the same shape, and the projecting part 51 fits and engages with the engagement receiving part 76.

In the blower 101, in the axial line X direction of the shaft 1, the projecting part 51 as the engagement part is located at an end part (one end part) on the lower side b of the sleeve 5, and the impeller 22 is fixed to the upper side a (other end) of the shaft 1 via the coupling member 23 and the hub 2.

The motor 100 to the blower 101 according to the present embodiment are configured as described above.

When a predetermined voltage is applied from an external power supply (not illustrated) to the motor 100 in the blower 101, a controlled current is supplied to the coil 62 via the circuit substrate 8. The action between the magnetic force generated in the stator 6 and the magnet 32 causes the impeller 22 to rotate about the rotation axial line X, for example, counterclockwise in FIG. 2. Due to the rotation of the impeller 22, air is suctioned into the case 7 from an intake port 77 on the upper side a and is blown out from an outlet port 78 on the lower side b.

Next, a method for assembling the motor 100 of the present embodiment and the blower 101 with the same applied will be described.

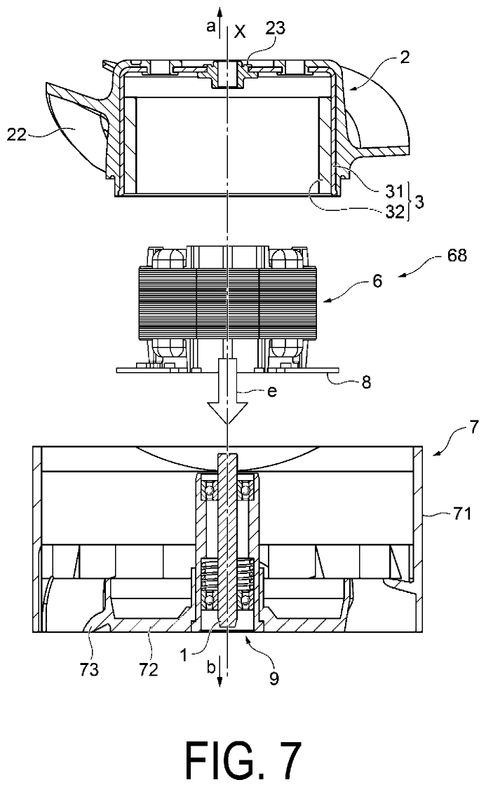

First, as illustrated in FIG. 6, the bearing cartridge 9 assembled in advance is inserted into the case tubular part 75 of the case 7 from the lower side b of the case 7 with an end part of the sleeve 5 on a side (upper side a) opposite to the projecting part 51 facing the upper side a (see arrow d). Then, the sleeve 5 is inserted or press-fitted into the case tubular part 75 until the projecting part 51 of the sleeve 5 fits and engages with the engagement receiving part 76 of the case 7, and the sleeve 5 is fixed to the case tubular part 75 by using an adhesive as necessary. At the present stage, the state illustrated in FIG. 7 is obtained.

FIG. 7 is an exploded cross-sectional view of the blower 101 illustrating a state of the bearing cartridge 9 being inserted into and fixed to the case 7 from the state illustrated in FIG. 6.

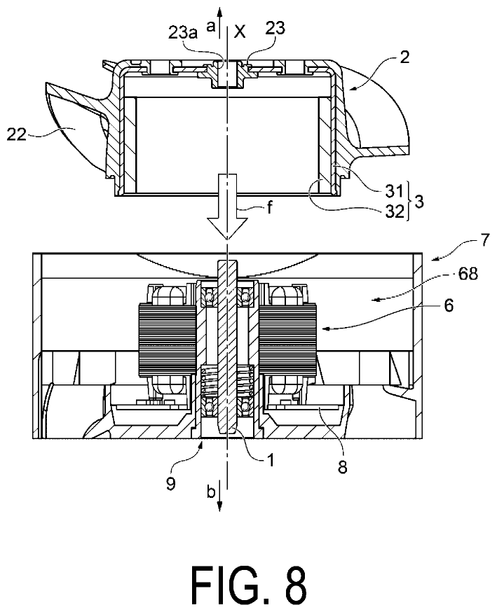

Next, as illustrated in FIG. 7, a stator assembly 68 having the insulator 63 of the stator 6 with the circuit substrate 8 attached is assembled from above the case 7 such that the bearing cartridge 9 is inserted into a cylindrical cavity of the stator 6 (see arrow e). At a predetermined position, the stator 6 is fixed to the bearing cartridge 9. The fixing of the stator 6 to the bearing cartridge 9 may be performed by press-fitting alone, by an adhesive alone, or by combining press-fitting and an adhesive as necessary. At the present stage, the state illustrated in FIG. 8 is obtained.

FIG. 8 is an exploded cross-sectional view of the blower 101 illustrating a state of the stator assembly 68 being inserted into and fixed to the bearing cartridge 9 from the state illustrated in FIG. 7.

As illustrated in FIG. 8, the hub 2 including the impeller 22 and the rotor 3 is assembled from above the case 7 such that the shaft 1 is inserted into an attaching hole 23a formed at the center of the coupling member 23 (see arrow f). Then, the hub 2 is fixed to the shaft 1 via the coupling member 23. The fixing of the coupling member 23 to the shaft 1 may be performed by press-fitting alone, by an adhesive alone, or by combining press-fitting and an adhesive as necessary.

As described above, the blower 101 illustrated in FIG. 1 is assembled.

In the motor 100, when an air flow toward the lower side b is generated by the rotation of the impeller 22, a force acts to move the bearing cartridge 9 including the shaft 1 toward the upper side a in the axial line X direction (a force like a lift force of a helicopter acts). In the present embodiment, since the stator 6 is also fixed to the bearing cartridge 9, a force to move from the case tubular part 75 toward the upper side acts on a portion of the motor including the stator 6 and excluding the case 7.

However, in the motor 100 according to the present embodiment, the sleeve 5 includes the projecting part 51 as the engagement part engaging with the support part of the case 7. Therefore, movement of the bearing cartridge 9 from the case 7 toward the upper side a is suppressed, and movement of the shaft 1 and the pair of bearings 4 from the case 7 in the axial line x direction is suppressed. Therefore, the motor 100 according to the present embodiment can realize long-term durability even under a high load condition, such as high-speed rotation.

In addition, in the motor 100 according to the present embodiment, since the sleeve 5 includes the projecting part 51 as the engagement part to suppress movement with respect to the case 7, a firm fixing for suppressing the coming off is not necessary, and it is possible to avoid strong press-fitting for a firm fixing and reduce defects, such as a decrease in shaft alignment accuracy due to molding or the like.

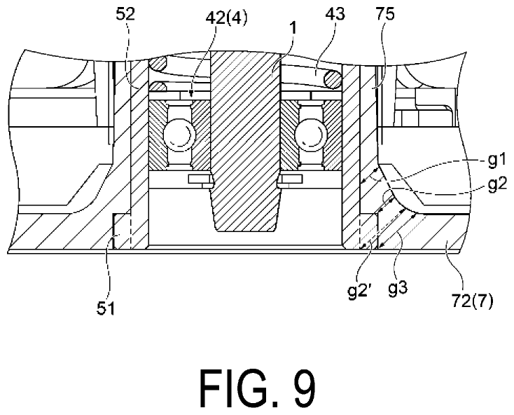

FIG. 9 is an enlarged cross-sectional view of the projecting part 51 of the sleeve 5 and the periphery of the projecting part 51 in the motor 100. As illustrated in FIG. 9, the bottom wall part 72 of the case 7 is provided with the engagement receiving part 76 as a support part engaging with the projecting part 51, and a corner part at a boundary between the bottom wall part 72 and the case tubular part 75 is in a state of being cut out accordingly. In other words, the length in the radial direction of the inner circumferential surface of the engagement receiving part 76 is greater than the length in the radial direction of an inner circumferential surface of the case tubular part 75.

When resin molding is performed, if the difference in resin thickness is great, deformation (shrinkage) after the molding process is likely to occur. For example, if the corner part remains at the boundary between the bottom wall part 72 and the case tubular part 75, as indicated by the dotted line in FIG. 9, the part having the greatest resin thickness has the length of the line segment indicated by the dotted double-headed arrow g2′, but in the motor 100 according to the present embodiment, since the corner part having the greatest thickness is cut out to form a recessed part, the part is the length of the line segment indicated by the solid double-headed arrow g2. Therefore, as indicated by the double-headed arrows g1 to g3, the difference in resin thickness is suppressed, deformation (shrinkage) at the time of molding is suppressed, and the finish accuracy is improved. Note that, as illustrated in FIG. 9, when the length of the thinnest portion of the recess provided in the engagement receiving part 76 is g2, and a line segment parallel to g2 and extending from the end part of the engagement receiving part 76 on one side in the axial direction (arrow b direction) to the end part of the case 7 is g3, g2<g3 is satisfied.

In the motor 100 according to the present embodiment, in the axial line X direction of the shaft 1, the projecting part 51 corresponding to the engagement part does not overlap with the pair of bearings 41, 42 and is disposed close to the end part (close to the lower side b in the present embodiment) of the shaft 1. In other words, the engagement part is displaced from the pair of bearings in the axial direction, and is disposed close to an end part of the shaft.

If the engagement part is located at a position overlapping with the bearing in the axial direction, there could be a concern of stress applied to the engagement part being transmitted to the bearing when the bearing cartridge is incorporated into the case or when the rotor rotates and generates a force to move in the axial direction. However, in the present embodiment, since the projecting part 51 corresponding to the engagement part does not overlap with any of the pair of bearings 41, 42, it is possible to suppress the stress applied to the projecting part 51 from being directly transmitted to the pair of bearings 41, 42. In particular, since the projecting part 51 is disposed close to an end part of the shaft 1, the stress applied to the projecting part 51 is easily released, and the force transmitted to the bearings 41, 42 can be further reduced.

In the motor 100 according to the present embodiment, in the axial line X direction of the shaft 1, the projecting part 51 corresponding to the engagement part is disposed so as to be spaced apart from any of the pair of bearings 41, 42. With the projecting part 51 being spaced apart from the pair of bearings 41, 42, it is possible to further suppress transmission of the stress applied to the projecting part 51 to the pair of bearings 41, 42.

In the motor 100 according to the present embodiment, the projecting part 51 corresponding to the engagement part projects radially outward from the tubular part 52. Since the projecting part 51 directly projects from the tubular part 52, it is possible to increase the rigidity of the projecting part 51 compared with a case of some member being interposed between the tubular part 52 and the projecting part 51.

In the motor 100 according to the present embodiment, the length in the radial direction of the projecting part 51 (that is, the distance in the radial direction from an outer circumferential surface of the tubular part 52 to the outer circumferential surface of the projecting part 51) is not particularly limited, but is preferably equal to or greater than half the thickness in the radial direction of the large-diameter circular tube (portions formed with the first large-inner-diameter part 54a and the second large-inner-diameter part 54b) in the tubular part 52. Accordingly, movement of the bearing cartridge 9 from the case 7 toward the upper side a is further suppressed.

In the motor 100 according to the present embodiment, the length in the radial direction of the projecting part 51 (that is, the distance in the radial direction from the outer circumferential surface of the tubular part 52 to the outer circumferential surface of the projecting part 51) is not particularly limited, but is preferably three times or less, more preferably two times or less the length in the radial direction of the large-diameter circular tube (portions formed with the first large-inner-diameter part 54a and the second large-inner-diameter part 54b) of the tubular part 52. Thus, the strength of the projecting part 51 can be improved.

In the motor 100 according to the present embodiment, the length in the axial direction of the projecting part 51 is preferably substantially equal to or larger than the thickness in the radial direction (that is, the distance in the radial direction from the outer circumferential surface of the tubular part 52 to the outer circumferential surface of the projecting part 51). Thus, the strength of the projecting part 51 can be improved.

In the motor 100 according to the present embodiment, in the axial line X direction of the shaft 1, the projecting part 51 corresponding to the engagement part is located at an end part (in the present embodiment, an end part close to the lower side b) of the sleeve 5. Since the projecting part 51 is located at the end part of the sleeve 5, the stress applied to the projecting part 51 is easily released, and the force transmitted to the bearings 41, 42 can be further reduced.

Further, in the axial line X direction of the shaft 1, the projecting part 51 is engaged with an end part (in the present embodiment, an end part close to the lower side b) of the case 7. Since the projecting part 51 engages with the end part of the case 7, the assembly operation of the motor 100 is easy. In addition, since the engagement is made at the end part of the case 7, a surface (in the present embodiment, a surface on the lower side b, bottom wall part 72) of the case 7 engaged by the projecting part 51 is in a flush state. Therefore, the bearing cartridge 9 can be easily inserted, and it is possible to suppress a decrease in accuracy of the motor 100 due to an impact caused by the bearing cartridge 9 being carelessly brought into contact with the case 7. Further, when the bearing cartridge 9 is removed for replacement or the like, workability is better when the projecting part 51 is disposed at the end part.

In the motor 100 according to the present embodiment, the projecting part 51 corresponding to the engagement part has a surface (surface 51a in FIG. 3) in contact with the case 7 in the axial line X direction of the shaft 1. Since the projecting part 51 comes into contact with the case 7 in the axial line X direction of the shaft 1, the bearing cartridge 9 easily resists a force to come off in the axial line X direction, and is coming off of the bearing cartridge 9 is easily stopped.

In the motor 100 according to the present embodiment, in the axial direction (axial line X direction) of the shaft 1, a planar shape (referring to a shape viewed from the axial direction (axial line X direction) of the shaft 1) of the projecting part 51 corresponding to the engagement part is circular. Therefore, if no particular measures are taken, there is a concern of the bearing cartridge 9 possibly rotating when a force to rotate the bearing cartridge 9 with respect to the case 7 acts.

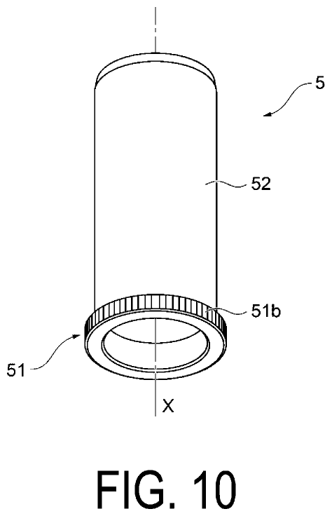

FIG. 10 illustrates an enlarged perspective view of the sleeve 5 according to the present embodiment. As illustrated in FIG. 10, the projecting part 51 has a circular shape when viewed from the axial line X direction of the shaft 1, and the outer circumferential surface of the projecting part 51 is subjected to a knurling process 51b. With the outer circumferential surface of the projecting part 51 being subjected to the knurling process 51b, friction is generated between the outer circumferential surface of the projecting part 51 and the surface (surface 76a in FIGS. 1 and 5) of the engagement receiving part 76 opposed to the outer circumferential surface of the projecting part 51. Therefore, the rotation of the bearing cartridge 9 is suppressed. In other words, the outer circumferential surface of the projecting part 51 and the inner circumferential surface of the engagement receiving part 76 are in contact in the radial direction. Preferably, the outer diameter of the outer circumferential surface of the projecting part 51 is larger than the inner diameter of the inner circumferential surface of the engagement receiving part 76. Therefore, the motor 100 according to the present embodiment can realize long-term durability even under a high load condition, such as high-speed rotation.

As illustrated in FIG. 10, in the present embodiment, the knurling process 51b applied onto the outer circumferential surface of the projecting part 51 includes a plurality of slit-like cuts formed in the outer circumferential surface in the axial line X direction. However, the shape of the knurling process is not limited, and may be any uneven shape, such as a shape having unevenness in a dimple shape or a checkered pattern.

Note that, in the above embodiment, an example of the projecting part 51 having a flange shape is given. However, the entire circumference of the projecting part 51 need not be a flange-like circular shape, and may be, for example, a shape being partially chipped in a radial form. With the outer circumferential surface excluding the chipped portion being subjected to the knurling process, rotation of the bearing cartridge is similarly suppressed.

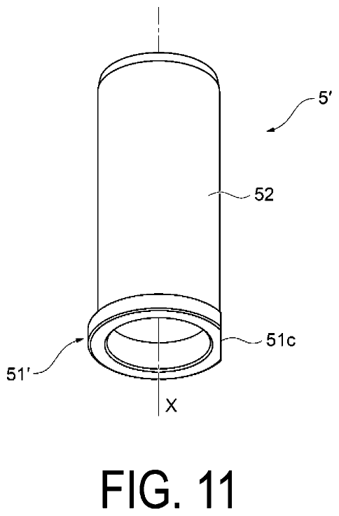

The method for stopping the rotation of the bearing cartridge with respect to the case 7 is not limited to the method of applying the knurling process 51b on the outer circumferential surface of the projecting part 51 of the sleeve 5. FIG. 11 illustrates an enlarged perspective view of a sleeve 5′ in a modified example. In the sleeve 5′, the tubular part 52 has the same shape as the shape of the sleeve 5, but the planar shape of a projecting part 51′ in the axial line X direction of the shaft 1 is a shape other than a circular shape.

In particular, when viewed from the axial line X direction of the shaft 1, the planar shape of the projecting part 51′ is a shape having a cut-out part 51c formed by cutting out a portion of the circular outer circumference so as to form a linear shape. Since an outer circumferential surface of the projecting part 51′ and an inner circumferential surface of an engagement receiving part 76′ are in contact in the circumferential direction, the presence of the cut-out part 51c causes rotation stopping on the sleeve 5′ and the rotation of the bearing cartridge 9 is restricted. Note that, the shape of the cut-out part 51c is not limited to a linearly cut-out shape, but may be a shape formed by the circular outer circumferential part being cut out in a fan shape or the like, and is not particularly limited.

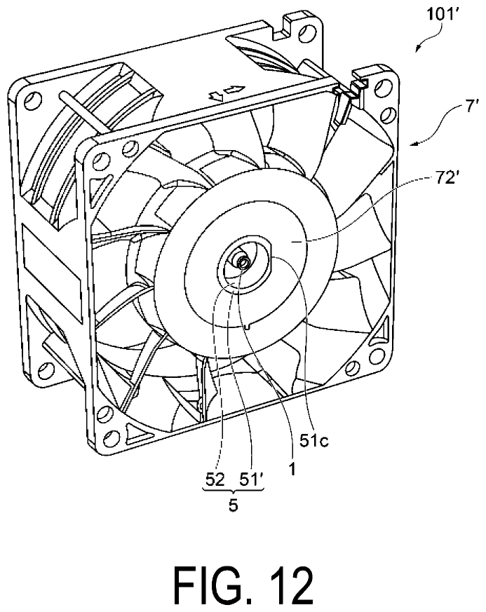

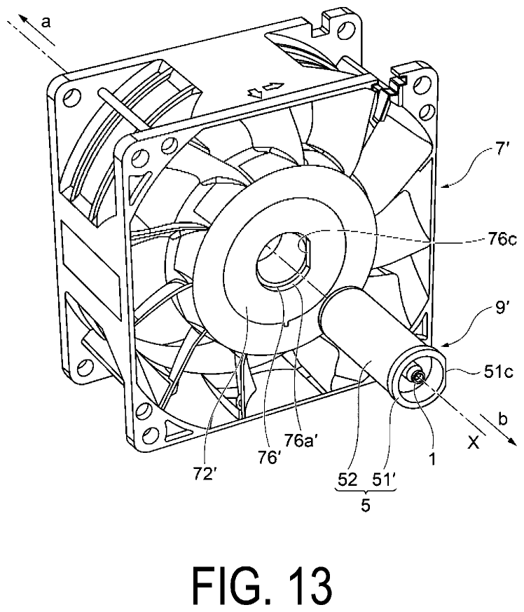

FIG. 12 is a perspective view of a blower 101′ provided with a motor with the sleeve 5′ of the modified example applied and illustrated in FIG. 11. FIG. 13 is an exploded perspective view illustrating a state of extracting a bearing cartridge 9′ alone from the blower 101′ provided with the motor with the sleeve 5′ of the modified example applied and illustrated in FIG. 11.

As illustrated in FIGS. 12 and 13, in a bottom wall part 72′ of a case 7′, the engagement receiving part 76′ has a shape corresponding to the projecting part 51′ of the sleeve 5′. In particular, the engagement receiving part 76′ has a shape, and in this shape, only the part of a linear part 76c linearly projects toward the axial line X with respect to the circular shape.

The engagement receiving part 76′ corresponds to the projecting part 51′ of the sleeve 5′, and by the projecting part 51′ fitting into the engagement receiving part 76′, the rotation stopping occurs. Therefore, in the motor with the sleeve 5′ of the modified example applied, the rotation of the bearing cartridge 9′ is restricted. Therefore, the motor 100 with the sleeve 5′ of the modified example applied can realize long-term durability even under a high load condition, such as high-speed rotation.

While the sleeve 5′ of the modified example illustrated in FIG. 11 has been given as an example of the rotation stopper of the bearing cartridge with respect to the case 7, the projecting part may have any planar shape other than a circular shape. Any planar shape other than a circular shape can get caught in the rotational direction and therefore the rotation of the bearing cartridge is suppressed.

As an example of the projecting part having a planar shape other than a circular shape, for example, a shape provided with one or a plurality of recessed parts from the outer circumference of the projecting part 51 having a flange shape (one not subjected to the knurling process) toward the center illustrated in FIG. 10 can be given. In the case, it is sufficient for the inner circumferential surface of the engagement receiving part (support part) provided at the bottom wall part of the case to be formed into a shape corresponding to the shape of the projecting part (shape for the projecting part to fit in). The shape provided at the outer circumference of the projecting part may be a protruded part instead of a recessed part, and the inner circumferential surface of the engagement receiving part (support part) may be formed in a recessed shape corresponding to the shape of the projecting part.

Further, in one aspect, the inner circumferential surface of the engagement receiving part (support part) may also be provided with a recessed part opposed to the recessed part of the projecting part, and a separate detent key may be inserted between the opposing recessed parts. Note that, depending on the shape provided at the outer circumference of the projecting part, even if the shape of the inner circumferential surface of the engagement receiving part (support part) remains circular and the outer circumference of the projecting part and the inner circumference of the engagement receiving part (support part) does not have a fitting relationship, the shape functions as a rotation stopper similarly to the knurling process, and the rotation of the bearing cartridge is suppressed.

Note that, since the knurling process is a process of imparting fine unevenness to the outer circumferential surface, the planar shape of the projecting part having unevenness formed on the outer circumferential surface cannot be strictly regarded as circular in some cases. However, the planar shape of the projecting part in a state of fine unevenness formed by the knurling process on the circular outer circumferential surface is included in the concept of a “circular shape” in the present embodiment. On the other hand, the planar shape of the projecting part in a state of great unevenness exceeding the uneven shape formed by the knurling process being formed on the circular outer circumferential surface is included in the concept of a “shape other than a circular shape” in the present embodiment.

The rotation stopping process is not limited to the process on the outer circumferential surface of the projecting part or the method of controlling the shape viewed from the axial direction of the shaft, but may be other means as long as the rotation of the bearing cartridge is suppressed. In one aspect of the rotation stopping process, for example, a recessed part or a protruded part in the axial direction may be provided at the flange surface (surface facing the lower side b) of the projecting part 51 (one not subjected to the knurling process) having a flange shape illustrated in FIG. 10, and a recessed part or a protruded part to fit into the recessed part or the protruded part may be provided at the case side such that both sides are fitted and locked to each other.

The motor of the disclosure, the blower using the same (hereinafter, referred to as the “motor and the like”), and the cartridge for the motor have been described above with reference to a preferred embodiment, but the motor and the like of the disclosure is not limited to the configuration of the embodiment described above. For example, in the above embodiment, a configuration including the bearing cartridge 9 has been described as examples. However, the disclosure can be applied to any aspect of a pair of bearings being attached to a case via a sleeve regardless of whether the bearings are in a cartridge form or not.

Also, the above embodiment has been described with an example of the motor 100 according to the disclosure being applied to the blower 101. However, the disclosure can be applied to various motor usage situations besides a blower. A motor with a bearing cartridge being unlikely to come off in the axial direction is desired for applications besides the blower as well, and the motor according to the disclosure can be suitably used.

Further, in the above embodiment, the spring 43 as the urging member is used for applying the preload to the pair of bearings 4 until the bearings are bonded and fixed, but the urging member is not an essential configuration in the disclosure. It is also possible not to apply a preload to the pair of bearings 4, and it is also possible to apply a preload to the pair of bearings 4 without using an urging member.

Two modified examples (“back-to-back combination example” and “front-to-front combination example”) capable of applying preloads to the pair of bearings 4 without using an urging member will be described below with reference to the drawings.

### Back-to-Back Combination Example

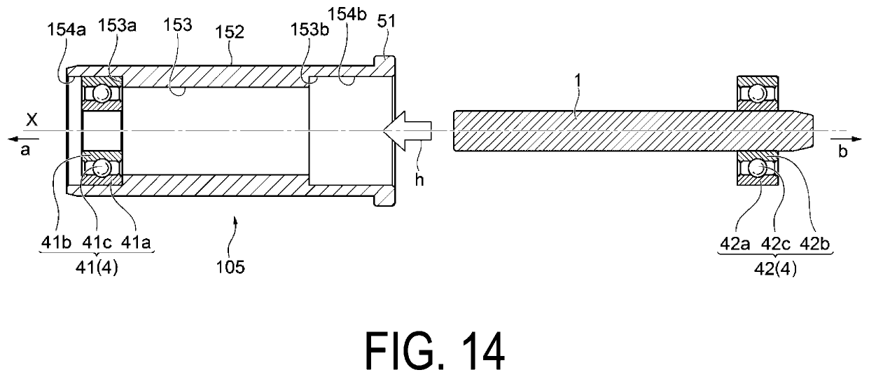

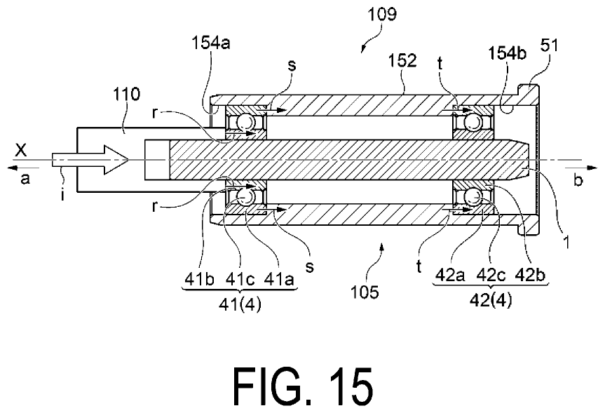

FIG. 14 is an exploded cross-sectional view illustrating an exploded state of a bearing cartridge (cartridge) 109 of a “back-to-back combination example” among two modified examples capable of applying preloads to the pair of bearings 4 without using an urging member. FIG. 15 is a cross-sectional view illustrating the bearing cartridge 109 of the “back-to-back combination example”.

Note that, in FIGS. 14 and 15, members having structures and functions similar to the structures and functions of the bearing cartridge 9 of the above embodiment are denoted by the same reference numerals as the reference numerals of the bearing cartridge 9 of the above embodiment, and a detailed description of the members will be omitted. Also, the vertical directions a and b are illustrated as horizontal directions in the drawings of FIGS. 14 and 15.

An inner circumferential surface of a sleeve 105 in the bearing cartridge 109 of the “back-to-back combination example” includes: in the axial line X direction, a wide region close to the upper side a including the center part protruding toward the axial line X as a protruding part (small-diameter inner circumferential part. Hereinafter, sometimes referred to as a “spacer part”) 153; a region on the upper side a with respect to the spacer part 153 being recessed in a direction away from the axial line X as a first recessed part (large-diameter inner circumferential part) 154a; and a region on the lower side b with respect to the spacer part 153 being recessed similarly to the first recessed part 54a as a second recessed part (large-diameter inner circumferential part) 154b. Hereinafter, in terms of the size of the inner diameters, the spacer part 153 may be referred to as a small inner-diameter part 153, the first recessed part 154a may be referred to as a first large-inner-diameter part 154a, and the second recessed part 154b may be referred to as a second large-inner-diameter part 154b.

Compared with the sleeve 5 of the bearing cartridge 9 in the above embodiment, in the sleeve 105 of the bearing cartridge 109 of the “back-to-back combination example”, the length of the small inner-diameter part 153 in the axial line X direction is made longer, and accordingly, the length of the second large-inner-diameter part 154b in the axial line X direction is made shorter. Note that, the length of the first large-inner-diameter part 154a in the axial line X direction is the same as the length of the first large-inner-diameter part 54a in the axial line X direction in the above embodiment.

When the bearing cartridge 109 of the “back-to-back combination example” is assembled, first, as illustrated in FIG. 14, the outer ring 41a of the first bearing 41 located at the upper side a of the shaft 1 is fitted into the first large-inner-diameter part 154a of the sleeve 105, and is positioned by a stepped part 153a at the boundary between the small inner-diameter part 153 and the first large-inner-diameter part 154a. The first bearing 41 is fixed to and supported by the sleeve 105 appropriately by an adhesive, light press-fitting, press-fitting, or the like.

Further, as illustrated in FIG. 14, the shaft 1 fits into the inner ring 42b of the second bearing 42, and is fixed and supported at a position on the lower side b of the shaft 1 appropriately by an adhesive, light press-fitting, press-fitting, or the like.

Then, the shaft 1 fixed to and supported by the second bearing 42 enters the second large-inner-diameter part 154b of the sleeve 5 from the lower side b with the axial line X as a center axis (see arrow h in FIG. 14). The tip end on the upper side a of the shaft 1 advances in the upper side a direction, and fits into the inner ring 41b of the first bearing 41. On the other hand, on the lower side b of the shaft 1, the attached second bearing 42 is fitted into the second large-inner-diameter part 154b.

As illustrated in FIG. 15, the second bearing 42 is pushed toward the upper side a and positioned until the outer ring 42a comes into contact with a stepped part 153b at the boundary between the small inner-diameter part 153 and the second large-inner-diameter part 154b. Then, in the present example, as illustrated in FIG. 15, a load is applied to the inner ring 41b of the first bearing 41 in the arrow i direction by using a pressing jig 110. That is, the inner ring 41b is urged in the arrow r direction in FIG. 15.

Further, the load in the arrow r direction applied to the inner ring 41b of the first bearing 41 by the pressing jig 110 is transmitted to the outer ring 41a via the balls 41c, and acts to urge the outer ring 41a against the stepped part 153 a in the arrow s direction in FIG. 15. In the sleeve 105, the stepped part 153a being back to back with the stepped part 153b is in contact with the outer ring 42a of the second bearing 42. As a result, by the influence of the load of the pressing jig 110, the stepped part 153b urges the outer ring 42a in the arrow t direction in FIG. 15 via the spacer part 153 of the sleeve 105.

In the state, the shaft 1 and the inner ring 41b of the first bearing 41 are fixed to each other, and the outer ring 42a of the second bearing 42 and the second large-inner-diameter part 154b and the stepped part 153b are fixed to each other with an adhesive or the like. When the load in the arrow i direction by the pressing jig 110 is released, the influence of the load remains, and the outer ring 42a remains in a preload application state of preload to be energized in the arrow t direction by the stepped part 153b. In addition, due to a reaction force generated by releasing the load applied by the pressing jig 110, the outer ring 41a is in a preload application state of preload to be urged in a direction (referred to as an “arrow s′ direction”) opposite to the arrow s direction by the stepped part 153a.

As described above, in the bearing cartridge 109 of the “back-to-back combination example”, preloads are applied to the pair of bearings 4 without using an urging member.

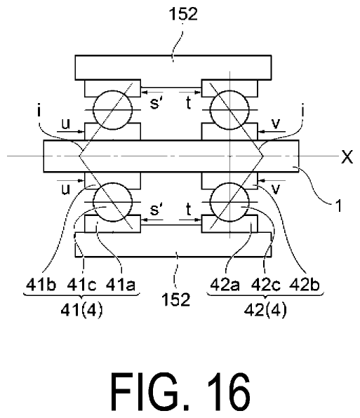

FIG. 16 is an explanatory view schematically illustrating the action of the preload on the pair of bearings 4 in the present example. FIG. 16 is merely a schematic view, and dimensions and the like do not correspond to the reality.

In the bearing cartridge 109 of the “back-to-back combination example”, outward (arrow s′, arrow t) preloads are applied to the outer ring 41a of the first bearing 41 and the outer ring 42a of the second bearing 42. Accordingly, between the outer rings 41a, 42a and the balls 41c, 42c, respectively, points on the straight lines i are the centers of the contact parts, and the forces due to the preloads are concentrated on the points. In the forces transmitted to the balls 41c, 42c as well, between the balls 41c, 42c and the inner rings 41b, 42b, respectively, points on the straight lines i are the centers of the contact parts, and the forces due to the preloads are concentrated on the points. Since the centers of the contact parts with the concentrated forces are aligned on the straight lines i, slipping of the balls 41c, 42c is suppressed, and stable rolling is realized.

As described above, in the bearing cartridge 109 of the “back-to-back combination example”, since the preloads applied to the pair of bearings 4 are stable, rattling of the bearings 4 can be suppressed. Therefore, the shaft 1 smoothly rotates, and high-speed rotation and high durability of the motor can be realized.

Note that, in the bearing cartridge 9 of the above embodiment described with reference to FIG. 3 and the like, the preload using the spring 43 is the same as the preload mechanism described with reference to FIG. 16.

While the bearing cartridge 109 of the “back-to-back combination example” and the bearing cartridge 9 of the above embodiment are examples of outward (arrow s′, arrow t) preloads being applied to the outer ring 41a of the first bearing 41 and the outer ring 42a of the second bearing 42, the preload mechanism is the same when inward preloads are applied to the inner ring 41b of the first bearing 41 and the inner ring 42b of the second bearing 42 as indicated by arrow u and arrow v in FIG. 16.

### Front-to-Front Combination Example

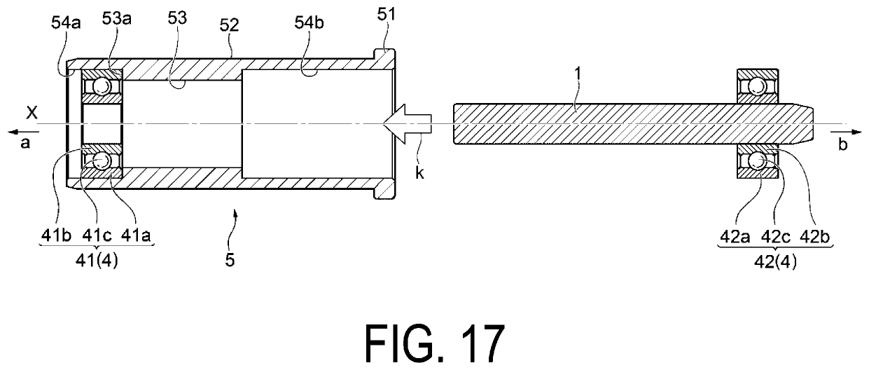

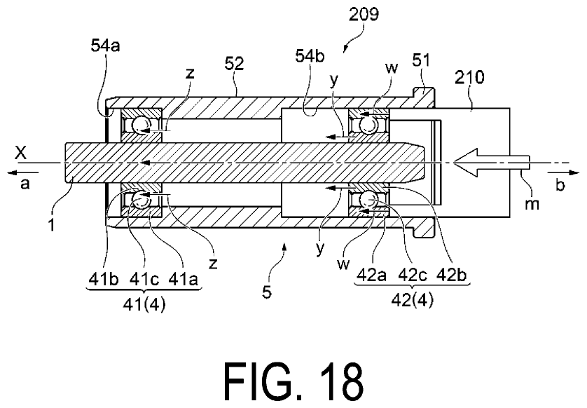

FIG. 17 is an exploded cross-sectional view illustrating an exploded state of a bearing cartridge (cartridge) 209 of a “front-to-front combination example” among two modified examples capable of applying preloads to the pair of bearings 4 without using an urging member. FIG. 18 is a cross-sectional view illustrating the bearing cartridge 209 of the “front-to-front combination example”.

Note that, in FIGS. 17 and 18, members having structures and functions similar to the structures and functions of the bearing cartridge 9 of the above embodiment are denoted by the same reference numerals as the reference numerals of the bearing cartridge 9 of the above embodiment, and a detailed description of the members will be omitted. Components of the bearing cartridge (cartridge) 209 of the “front-to-front combination example” include components of the bearing cartridge 9 of the above embodiment excluding the spring 43. Also, the vertical directions a and b are illustrated as horizontal directions in the drawings of FIGS. 17 and 18 as well.

When the bearing cartridge 209 of the “front-to-front combination example” is assembled, similarly to the above embodiment illustrated in FIG. 4, and as illustrated in FIG. 17, the first bearing 41 located at the upper side a of the shaft 1 is fixed to and supported by the sleeve 5. Similarly, at a position on the lower side b of the shaft 1, the shaft 1 is fixed and supported by the second bearing 42.

Then, the shaft 1 fixed to and supported by the second bearing 42 enters the second large-inner-diameter part 54b of the sleeve 5 from the lower side b with the axial line X as a center axis (see arrow k in FIG. 17). The tip end on the upper side a of the shaft 1 advances in the upper side a direction, and fits into the inner ring 41b of the first bearing 41. On the other hand, on the lower side b of the shaft 1, the attached second bearing 42 is fitted into the second large-inner-diameter part 54b.

As illustrated in FIG. 18, the second bearing 42 is pushed toward the upper side a until reaching a predetermined position. Then, in the present example, as illustrated in FIG. 18, a load is applied to the outer ring 42a of the second bearing 42 in the arrow m direction by using a pressing jig 210. That is, the outer ring 42a is urged in the arrow w direction in FIG. 18.

Further, the load in the arrow w direction applied to the outer ring 42a of the second bearing 42 by the pressing jig 210 is transmitted to the inner ring 42b via the balls 42c, and acts to urge the inner ring 41b in the arrow y direction and the shaft 1 in the upper direction a in FIG. 18. The inner ring 41b of the first bearing 41 is fixed to the upper side a of the shaft 1, and as a result, by the influence of the load of the pressing jig 210, the inner ring 41a is urged in the arrow z direction in FIG. 18 via the shaft 1.

In the state, the shaft 1 and the inner ring 41b of the first bearing 41 are fixed to each other, and the outer ring 42a of the second bearing 42 and the second large-inner-diameter part 54b are fixed to each other with an adhesive or the like. When the load in the arrow m direction applied by the pressing jig 210 is released, the influence of the load remains, and the inner ring 41b remains in a preload application state of the preload to be energized in the arrow z direction by the shaft 1. In addition, due to a reaction force generated by releasing the load applied by the pressing jig 210, the inner ring 42b is in a preload application state of a preload to be urged in a direction (referred to as an “arrow y′ direction”) opposite to the arrow y direction by the shaft 1.

As described above, in the bearing cartridge 209 of the “front-to-front combination example”, a preload is applied to the pair of bearings 4 without using an urging member.

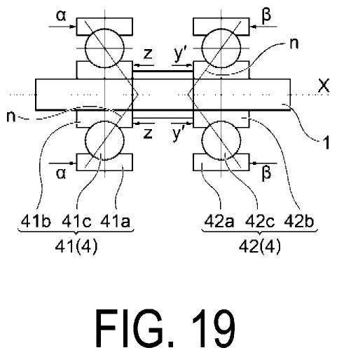

FIG. 19 is an explanatory view schematically illustrating the action of the preloads on the pair of bearings 4 in the present example. FIG. 19 is merely a schematic view, and dimensions and the like do not correspond to reality.

In the bearing cartridge 209 of the “front-to-front combination example”, outward (arrow z, arrow y′) preloads are applied to the inner ring 41b of the first bearing 41 and the inner ring 42b of the second bearing 42. Accordingly, between the inner rings 41b, 42b and the balls 41c, 42c, respectively, points on the straight lines n are the centers of the contact parts, and the forces due to the preloads are concentrated on the points. In the forces transmitted to the balls 41c, 42c as well, between the balls 41c, 42c and the outer rings 41a, 42a, respectively, the points on the straight lines n are the centers of the contact parts, and the forces due to the preloads are concentrated on the points. Since the centers of the contact parts with the concentrated force are aligned on the straight lines n, slipping of the balls 41c, 42c is suppressed, and stable rolling is realized.

As described above, in the bearing cartridge 209 of the “front-to-front combination example”, since the preloads applied to the pair of bearings 4 are stable, rattling of the bearings 4 can be suppressed. Therefore, the shaft 1 smoothly rotates, and high-speed rotation and high durability of the motor can be realized.

Note that, while the bearing cartridge 209 of the “front-to-front combination example” is an example of outward (arrow z, arrow y′) preloads being applied to the inner ring 41b of the first bearing 41 and the inner ring 42b of the second bearing 42, the preload mechanism is the same when inward preloads are applied to the outer ring 41a of the first bearing 41 and the outer ring 42a of the second bearing 42 as indicated by arrow a and arrow R in FIG. 19.

In addition, the motor according to the disclosure can be appropriately modified by a person skilled in the art according to known knowledge in the past. Such modifications are of course included in the scope of the disclosure as long as these modifications still include the configuration of the disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A motor comprising:
a shaft;
a rotor fixed to the shaft;
a stator opposed to the rotor;
a pair of bearings fixed to the shaft;
a sleeve surrounding the pair of bearings; and
a case including a support part configured to support the sleeve, wherein
the sleeve includes an engagement part configured to engage with the support part of the case in an axial direction of the shaft.

2. The motor according to claim 1, wherein
in the axial direction of the shaft, the engagement part is disposed at a portion of the sleeve being located at an end part side of the shaft with respect to the pair of bearings.

3. The motor according to claim 1, wherein
in the axial direction of the shaft, the engagement part has a surface opposed to the support part of the case.

4. The motor according to claim 1, wherein
the sleeve has an inner circumferential surface and an outer circumferential surface; and
in a radial direction, the engagement part includes a projecting part projecting in a direction from the inner circumferential surface toward the outer circumferential surface of the sleeve.

5. The motor according to claim 4, wherein
the projecting part has a flange shape.

6. The motor according to claim 1, wherein
the engagement part is located at an end part of the sleeve in the axial direction of the shaft.

7. The motor according to claim 6, wherein
the engagement part engages with an end part of the support part of the case in the axial direction of the shaft.

8. The motor according to claim 1, wherein
the engagement part is formed with a rotation stopper with respect to the support part of the case.

9. The motor according to claim 1, wherein
a planar shape of the engagement part is a shape different from a circular shape in the axial direction of the shaft.

10. The motor according to claim 1, wherein
in the axial direction of the shaft, a planar shape of the engagement part is a circular shape; and
an outer circumferential surface of the engagement part is subjected to a knurling process.

11. The motor according to claim 1, comprising
an urging member configured to urge one bearing of the pair of bearings in the axial direction of the shaft.

12. The motor according to claim 11, wherein
the urging member is disposed between the pair of bearings.

13. A blower comprising:
the motor according to claim 1; and
an impeller fixed to the shaft.

14. The blower according to claim 13, wherein
in the axial direction of the shaft, the engagement part is located at one end part of the sleeve; and
the impeller is fixed to another end part of the shaft located at another end part side of the sleeve.

15. A cartridge for a motor, comprising:
a pair of bearings; and
a sleeve having an outer circumferential surface and an inner circumferential surface surrounding the pair of bearings, wherein
the outer circumferential surface of the sleeve is provided with a projecting part projecting in a direction from the inner circumferential surface toward the outer circumferential surface.

16. The cartridge for a motor according to claim 15, wherein
the projecting part has a flange shape.

17. The cartridge for a motor according to claim 15, wherein
in a longitudinal direction of the sleeve, the projecting part is spaced apart from the pair of bearings, and is disposed at an end part side of the sleeve with respect to the pair of bearings.

18. The cartridge for a motor according to claim 15, wherein
the projecting part is located at an end part of the sleeve in a longitudinal direction of the sleeve.

19. The cartridge for a motor according to claim 15, comprising
a shaft supported by the pair of bearings.
